(19) United States
(12) Patent Application Publication
(10) Pub. No.: US 2024/0002101 A1
(43) Pub. Date: Jan. 4, 2024

(54) CONTAINER FOR ALCOHOLIC BEVERAGE, AND ALCOHOLIC BEVERAGE-CONTAINING CONTAINER

(71) Applicant: TOPPAN INC., Tokyo (JP)

(72) Inventors: Keisuke YAMAGUCHI, Tokyo (JP); Masafumi HORIUCHI, Tokyo (JP); Makoto TOKUNAGA, Fukuoka-shi (JP); Haruno MURAYAMA, Fukuoka-shi (JP); Masatoshi YAGI, Fukuoka-shi (JP)

(73) Assignee: TOPPAN INC., Tokyo (JP)

(21) Appl. No.: 18/368,335

(22) Filed: Sep. 14, 2023

Related U.S. Application Data
(63) Continuation of application No. PCT/JP2022/004658, filed on Feb. 7, 2022.

(30) Foreign Application Priority Data
Mar. 16, 2021 (JP) 2021-042421

(51) Int. Cl. B65D 5/56; B65D 81/26; B65D 85/72

(52) U.S. Cl. CPC B65D 5/563; B65D 81/266; B65D 85/72; B65D 2565/381

(57) ABSTRACT

A container for an alcoholic beverage, the container being formed of a laminated body provided with a substrate layer containing paper, a barrier layer, and a sealant film in this order from the outside, and having a resin layer containing zinc oxide particles provided further to the inside than the barrier layer. Also an alcoholic beverage-containing container comprising the container for an alcoholic beverage, and an alcoholic beverage that is accommodated in the container for an alcoholic beverage.

### CROSS-REFERENCE TO RELATED PATENT APPLICATIONS

This application is a continuation application filed under 35 U.S.C. § 111(a) claiming the benefit under 35 U.S.C. §§ 120 and 365(c) of International Patent Application No. PCT/JP2022/004658, filed on Feb. 7, 2022, which is based upon and claims the benefit of priority to Japanese Patent Application No. 2021-042421, filed on Mar. 16, 2021; the disclosures of which are incorporated herein by reference in their entirety.

### TECHNICAL FIELD

The present disclosure relates to a container for an alcoholic beverage, and an alcoholic beverage-containing container.

### BACKGROUND

There are many types of alcoholic beverages, such as Japanese sake, shochu, wine, whiskey, beer, and low-malt beer. Such alcoholic beverages contain various components. For example, as the aroma components of shochu, acetaldehyde, ethyl acetate, n-propyl alcohol, isobutyl alcohol, isoamyl acetate, isoamyl alcohol, furfural, monoterpene alcohols (linalool, α-terpineol, citronellol, nerol, and geraniol), ethyl caproate, ethyl caprylate, ethyl caprate, β-phenethyl alcohol, β-phenethyl acetate, and higher fatty acid ethyl esters are known (see PTL 1).

On the other hand, in alcoholic beverages, components that cause off-flavors can also be generated depending on the manufacturing conditions. In PTL 2, sulfur compounds such as hydrogen sulfide (H2S) are provided as examples of off-flavor components.

As the containers used for such alcoholic beverages containing various components, the use of containers made of resin with excellent handling properties in place of containers composed of conventional inorganic materials such as metals or glass has been investigated. In the case of such containers made of resin, there is a concern that deterioration of the contents may occur. Therefore, in PTL 3, a film containing amorphous carbon is provided on an inner surface side of a polyester resin container, a light-shielding film is provided on this inner surface side, and providing a container having content preserving properties that are suitable for sparkling alcoholic beverages has been investigated.

[Citation List] [Patent Literature] PTL 1: JP 2019-70548 A; PTL 2 JP 2017-6081 A; PTL 3: JP 2003-146334 A.]

### SUMMARY OF THE INVENTION

### Technical Problem

The flavor of alcoholic beverages containing various components may change depending on the manufacturing conditions and the environment when stored in a container. When non-metal and non-glass containers are used instead of metal and glass containers, there is a concern that components that give rise to unpleasant-smelling odors due to degradation may be generated. Hydrogen sulfide and other various sulfur compounds are involved in causing the unpleasant odors in alcoholic beverages.

Therefore, the present disclosure provides a container for an alcoholic beverage and an alcoholic beverage-containing container that enable the flavor of an alcoholic beverage to be well-preserved by selectively adsorbing the sulfur compounds that cause unpleasant odors.

### Solution to Problem

An aspect of the present disclosure provides a container for an alcoholic beverage, the container including a resin layer containing zinc oxide particles. The resin layer containing zinc oxide particles sufficiently adsorbs the sulfur compounds that cause unpleasant odors in an alcoholic beverage. On the other hand, a resin layer containing zinc oxide particles is unlikely to adsorb the aroma components that give rise to the pleasant aroma of an alcoholic beverage. In this way, by selectively adsorbing the sulfur compounds that cause unpleasant odors in an alcoholic beverage, the flavor of the alcoholic beverage can be well-preserved.

The zinc oxide particles may have a surface that has been subjected to hydrophobic treatment. As a result, the dispersibility of the zinc oxide particles contained in the resin layer improves, and the adsorption performance with respect to the sulfur compounds that cause unpleasant odors in an alcoholic beverage can be further improved. Furthermore, even when the dispersibility improves, the adsorption of the aroma components contained in an alcoholic beverage can be sufficiently suppressed.

The primary particle size of the zinc oxide particles may be 20 to 280 nm. Zinc oxide particles having such a size tend to aggregate, but they are commercially available and have sufficiently excellent adsorption performance with respect to the sulfur compounds that cause unpleasant odors in an alcoholic beverage.

The resin layer may contain a polyolefin resin, and the zinc oxide particles may be dispersed in the polyolefin resin. As a result, the heat-sealing properties can be sufficiently improved. In addition, zinc oxide particles can be contained with high dispersibility by suppressing the aggregation of the zinc oxide particles.

A content ratio of the zinc oxide particles in the resin layer may be 0.2 to 45% by weight. As a result, it is possible to achieve a high level of both the adsorption performance with respect to the sulfur compounds and the sealing properties.

A surface concentration of the zinc oxide particles in the resin layer may be 0.1 g/m² or more. As a result of having such a high surface concentration, the adsorption performance with respect to the sulfur compounds can be sufficiently increased. Note that, in the present disclosure, the “surface concentration” is a content ratio of the zinc oxide particles in the resin layer per 1 m² of a primary surface (first surface). The “surface concentration” in the present disclosure can be calculated by multiplying the weight (g) of the resin layer per 1 m² of the primary surface and the content ratio of the zinc oxide particles (% by weight).

The resin layer may substantially contain no dispersant. As a result, the quality and reliability can be further improved.

The container for an alcoholic beverage may be formed of a laminated body provided with a substrate layer containing paper, a barrier layer, and a sealant film in this order from the outside, and may be formed of a laminated body having the resin layer provided further to the inside than the barrier layer. Because such a laminated body has a barrier layer, it is possible to prevent the alcoholic beverage from coming into contact with the outside air. Furthermore, because the resin layer is provided further to the inside than the barrier layer, it is possible for the sulfur compounds that cause unpleasant odors in an alcoholic beverage to be adsorbed with sufficient selectivity. Note that, even when the resin layer is not provided further to the inside than the barrier layer, the adsorption of the aroma components contained in an alcoholic beverage can be sufficiently suppressed.

The sealant film may contain the resin layer, and a sealing layer further to the inside than the resin layer in which a content ratio of the zinc oxide particles is lower than in the resin layer. Such a sealant film can achieve a high level of both adsorption performance with respect to the sulfur compounds that cause unpleasant odors in an alcoholic beverage and the sealing properties.

A ratio of a thickness of the resin layer to a thickness of the sealing layer may be 1.5 to 5. As a result, it is possible to maintain the sealing properties at a high level, while also ensuring a sufficient amount of zinc oxide particles that absorb the unpleasant odors in an alcoholic beverage.

A content ratio of the zinc oxide particles in the sealant film as a whole may be 0.1 to 25% by weight. As a result, it is possible to achieve a high level of both adsorption performance with respect to the sulfur compounds that cause unpleasant odors in an alcoholic beverage and the sealing properties.

The container for an alcoholic beverage may be for an alcoholic beverage containing at least one selected from a group consisting of Japanese sake and shochu. The resin layer provided in the container for an alcoholic beverage sufficiently adsorbs sulfur compounds, such as hydrogen sulfide, that cause unpleasant odors, while also being unlikely to adsorb the aroma components that give rise to the pleasant aromas contained in Japanese sake and shochu. As a result, the container can be preferably used for Japanese sake and shochu, which require a good flavor.

The container for an alcoholic beverage may be a container for an alcoholic beverage containing a first component composed of one or more types of substances selected from a group consisting of 3-methyl-1-butanol, phenethyl alcohol, and linalool. The resin layer containing zinc oxide particles suppresses adsorption of the first component when an alcoholic beverage containing the first component, which is an aroma component, is accommodated. As a result, the flavor of the alcoholic beverage can be even better preserved.

The container for an alcoholic beverage may be a container for an alcoholic beverage containing a second component composed of one or more types of substances selected from a group consisting of DMS (dimethylsulfide), methional, methionol, s-methylthioacetate, and DMDS (dimethyldisulfide). The resin layer containing zinc oxide particles is capable of adsorbing such a second component with sufficient selectivity. Because the second component represents the components that cause unpleasant odors in an alcoholic beverage, the unpleasant odors can be sufficiently reduced by adsorbing these components.

The resin layer preferably has a higher total adsorption amount of a second component composed of one or more types of substances selected from a group consisting of DMS, methional, methionol, s-methylthioacetate, and DMDS than a total adsorption amount of a first component composed of one or more types of substances selected from a group consisting of 3-methyl-1-butanol, phenethyl alcohol, and linalool. As a result, the flavor of the alcoholic beverage can be even better preserved.

An aspect of the present disclosure provides an alcoholic beverage-containing container comprising: one of the containers for an alcoholic beverage described above; and an alcoholic beverage accommodated in the container for an alcoholic beverage. Because the alcoholic beverage-containing container is provided with one of the containers for an alcoholic beverage described above, it is capable of sufficiently adsorbing the sulfur compounds that cause unpleasant odors, and the flavor of an alcoholic beverage can be sufficiently well-preserved.

### Advantageous Effects of the Invention

It is possible to provide a container for an alcoholic beverage and an alcoholic beverage-containing container that enable the flavor of an alcoholic beverage to be well-preserved by selectively adsorbing the sulfur compounds that cause unpleasant odors.

### BRIEF DESCRIPTION OF THE DRAWINGS

FIG. 1 is a perspective view of a container for an alcoholic beverage and an alcoholic beverage-containing container according to an embodiment.

FIG. 2 is a cross-sectional view showing an example of a laminated body that constitutes the container for an alcoholic beverage.

### DETAILED DESCRIPTION

Hereinafter, an embodiment of the present disclosure will be described with reference to the drawings as appropriate. However, the following embodiment is an example for describing the present disclosure, and is not intended to limit the present disclosure to the following content. In the description, the same reference numerals are used for the same elements or elements having the same function, and repeated description is omitted in some cases. Moreover, the positional relationships, such as up and down, and left and right, are based on the positional relationships shown in the drawings unless otherwise specified. In addition, the dimensional ratios in the drawings are not limited to the ratios shown in the drawings.

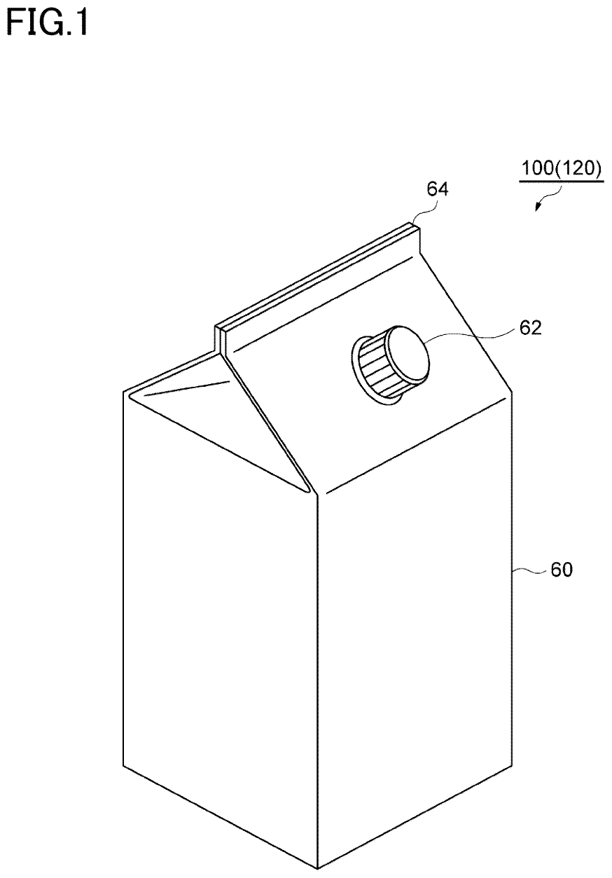

FIG. 1 is a perspective view of a container for an alcoholic beverage and an alcoholic beverage-containing container according to an embodiment. The container for an alcoholic beverage 100 includes a main body portion 60 that is configured to accommodate an alcoholic beverage, and a cap 62 attached to a filling port used to fill the main body portion 60 with an alcoholic beverage. When the container for an alcoholic beverage 100 accommodates an alcoholic beverage, an alcoholic beverage-containing container 120 is obtained. When the cap 62 is detached from the alcoholic beverage-containing container 120, the alcoholic beverage accommodated in the container for an alcoholic beverage 100 (main body portion 60) can be poured out from the filling port. In this way, the filling port also functions as a pouring port. Examples of the alcoholic beverage include Japanese sake such as refined sake, shochu, wine, whiskey, beer, and low-malt beer. The alcoholic beverage contains, in addition to ethanol, various aroma components and other minor components. Furthermore, depending on the conditions of the manufacturing process and storage conditions, the alcoholic beverage may contain components that cause unpleasant odors. Sulfur compounds are an example of a component that causes unpleasant odors. Sulfur compounds include hydrogen sulfide and sulfur compounds other than hydrogen sulfide.

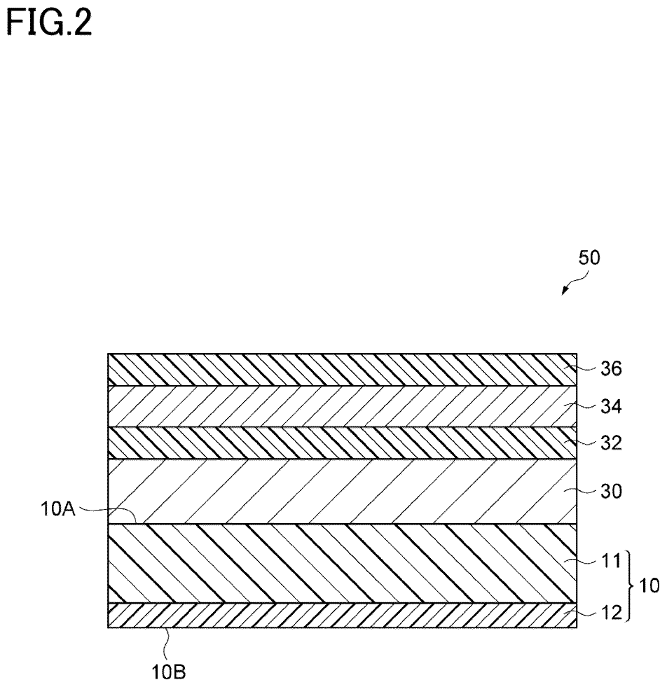

FIG. 2 is a cross-sectional view showing an example of a laminated body that constitutes the container for an alcoholic beverage 100. The laminated body 50 in FIG. 2 includes a sealant film 10, and a barrier layer 30, an intermediate layer 32, paper 34 (paper layer), and an outer layer 36 provided in this order from a resin layer 11 side on a first surface 10A of the sealant film 10. An other side 10B of the sealant film 10 and a first surface of the outer layer 36 are exposed. A sealing layer 12 of the sealant film 10 constitutes the inner surface of the container for an alcoholic beverage 100, and the outer layer 36 constitutes the surface of the container for an alcoholic beverage 100.

The sealant film 10 includes the resin layer 11 containing zinc oxide particles, and the sealing layer 12 in which the content ratio of zinc oxide particles is lower than in the resin layer 11. As a result, the first surface 10A side of the sealant film 10 constituted by the resin layer 11 has a higher content ratio of zinc oxide particles than the other side 10B. Note that the sealant film is not limited to a two-layered structure, and may be provided with one or more intermediate layers between the resin layer 11 and the sealing layer 12. Furthermore, the content ratio may have a gradient such that the content ratio of zinc oxide particles becomes lower from the first surface toward the other side 10B.

The thickness of the sealant film 10 may be, from the viewpoint of achieving both suitable sealing properties and flexibility, 20 to 150 μm, or 35 to 120 μm. The thickness of the resin layer 11 may be 15 to 100 μm, or 25 to 80 μm. The thickness of the sealing layer 12 may be 5 to 50 μm, or 10 to 40 μm. The ratio of the thickness of the resin layer 11 to the thickness of the sealing layer 12 may be 1.5 to 5, and may also be 2 to 4. As a result, it is possible to maintain the sealing properties at a sufficiently high level, while also ensuring a sufficient amount of zinc oxide particles that adsorb the sulfur compounds that produce unpleasant odors.

The resin layer 11 and the sealing layer 12 may be, for example, laminated films that are produced by co-extrusion. The content ratio of the zinc oxide particles in the resin layer 11 may be, for example, 0.2 to 45% by weight. The lower limit of the content ratio may be, from the viewpoint of sufficiently increasing the adsorption amount of the sulfur compounds, 0.5% by weight, 1% by weight, or 2% by weight. The upper limit of the content ratio may be, from the viewpoint of sufficiently increasing the sealing properties, 40% by weight, or 30% by weight.

The surface concentration of the zinc oxide particles in the resin layer 11 may be, for example, 0.1 g/m² or more, or 0.1 to 20 g/m². The lower limit of the surface concentration may be, from the viewpoint of sufficiently increasing the adsorption amount of the sulfur compounds that cause unpleasant odors, 0.3 g/m², 0.45 g/m², or 1 g/m². The upper limit of the surface concentration may be, from the viewpoint of sufficiently increasing the sealing properties, 16 g/m² or more, or 12 g/m².

The primary particle size of the zinc oxide particles contained in the resin layer 11 may be 20 to 280 nm, 20 to 200 nm, or 20 to 100 nm. The primary particle size of the zinc oxide particles is the median size (D50) at which the cumulative frequency is 50% in a volume-based particle size distribution measured by the laser diffraction/scattering method. Zinc oxide particles of such a size are commercially available.

The sealing layer 12 may or may not contain zinc oxide particles. The content ratio of the zinc oxide in the sealing layer 12 may be 1% by weight or less, 0.5% by weight or less, or by weight or less. As a result of reducing the content ratio of the zinc oxide particles, the unevenness of the other side 10B (the primary surface of the sealant film 10 on the sealing layer 12 side) is reduced, and the sealing properties can be sufficiently improved.

The content ratio of the zinc oxide particles in the sealant film 10 as a whole may be, for example, 0.1 to 25% by weight. The lower limit of the content ratio may be, from the viewpoint of sufficiently increasing the adsorption amount of the sulfur compounds, 0.3% by weight, 0.6% by weight, or 1% by weight. The upper limit of the content ratio may be, from the viewpoint of sufficiently increasing the sealing properties, 20% by weight, or 15% by weight.

The zinc oxide particles preferably have a surface that has been subjected to hydrophobic treatment. As a result, the aggregation of the zinc oxide particles contained in the sealant film 10 is suppressed, which improves the dispersibility, and the adsorption performance with respect to the sulfur compounds that cause unpleasant odors in the alcoholic beverage and the sealing properties can be further improved. Examples of hydrophobic treatment include treatment using at least one type of substance selected from a group consisting of polysiloxane, alkylsilane, alkylalkoxysilane and acrylic silicon. As a result of performing such treatment, the surface of the zinc oxide particles is made hydrophobic, and the dispersibility in the resin layer 11 can be improved. After being subjected to hydrophobic treatment, the zinc oxide particles may have a polysiloxane layer on the surface, such as a hydrogen dimethicone layer.

The sealant film 10 may contain a polyolefin resin, and the zinc oxide particles may be dispersed in the polyolefin resin. The resin layer 11 and the sealing layer 12 may contain the same polyolefin resin, or may contain different polyolefin resins. The polyolefin resin may be unstretched from the viewpoint of improving the heat-sealing properties. Examples of the polyolefin resin include linear low-density polyethylene (LLDPE), low-density polyethylene (LDPE), polypropylene (PP), ethylene-vinyl acetate copolymer (EVA), ethylene-propylene copolymer (EPR), and polymethylpentene (TPX). As a result, the heat-sealing properties of the sealant film 10 can be sufficiently improved.

The sealant film 10 may substantially contain no dispersant, or may contain no dispersant at all. Here, “substantially contain no dispersant” means that the dispersant may be present at the impurity level, or that the dispersant may be contained at a level that does not affect the performance of the sealant film 10. As a result, the reliability can be further improved when accommodating an alcoholic beverage. The dispersant is a component that is mixed with the resin composition when forming the sealant film, and has the effect of dispersing the solid components such as the zinc oxide particles. Examples include styrene acrylic resin copolymers, polyhydric alcohol fatty acid esters, nonionic surfactants, and fatty acid metal salts.

A manufacturing method of a sealant film according to an embodiment includes a step for obtaining a sealant film by co-extrusion of a first resin composition containing zinc oxide particles that have been subjected to hydrophobic treatment, and a second resin having a lower content ratio of zinc oxide particles than the first resin composition. The sealant film 10 may be obtained by forming the resin layer 11 from the first resin composition and the sealing layer 12 from the second resin composition, respectively. Because the zinc oxide particles have been subjected to hydrophobic treatment, they can be dispersed in the resin composition with a high uniformity.

The MFR (melt flow rate) of the first resin composition may be 1 to 8 g/10 min. As a result, the zinc oxide particles can be dispersed with sufficiently high uniformity without impairing the smoothness at the time of extrusion molding. The MFR of the second resin composition may also be 1 to 8 g/10 min.

As a result of using the sealant film 10 as the innermost layer of the container for an alcoholic beverage, it is possible to sufficiently adsorb the sulfur compounds that cause unpleasant odors from the alcoholic beverage. Furthermore, because the sealant film 10 has the sealing layer 12, which has a lower content ratio of the zinc oxide particles than the resin layer 11, further to the inside than the resin layer 11, the sealant film 10 has excellent sealing properties. The sealant film 10 can also adsorb sulfur compounds other than hydrogen sulfide that have a molecular weight of 120 or less.

The barrier layer 30 is a layer having barrier properties. Examples of the barrier layer 30 include vapor deposition films made of an inorganic substance, metal foils, resin films, and resin films laminated with a vapor deposition layer. Specific examples include inorganic vapor deposition films such as silica, aluminum vapor deposition films, aluminum foils, aluminum foil-laminated PET films, and various barrier films such as nylon-based barrier films and ethylene-vinyl alcohol-based barrier films. These may be used alone or in combination of two or more.

The thickness of the barrier layer 30 is not particularly limited. If the barrier layer is a vapor deposition layer, the thickness may be, for example, 5 to 100 nm. If the barrier layer is composed of aluminum foil, the thickness may be, for example, 7 to 9 μm. The barrier layer can be formed by, for example, a vacuum vapor deposition method, a sputtering method, an ion plating method, a plasma vapor deposition method (CVD), a dry lamination method, an extrusion lamination method, or the like.

The intermediate layer 32, the paper 34 and the outer layer 36 constitute a substrate layer of the laminated body 50. The intermediate layer 32 and the outer layer 36 may be configured by a resin film. Examples of the resin film include polyester films such as those of polyethylene terephthalate (PET) and polyethylene naphthalate (PEN); polyolefin films such as those of polyethylene and polypropylene; polystyrene films; polyamide films such as those of 6,6-nylon; polycarbonate films; polyacrylonitrile films; and polyimide films.

The material of the intermediate layer 32 and the outer layer 36 may be the same or different. The intermediate layer 32 and the outer layer 36 may use the resin films mentioned above alone or in combination of two or more. The intermediate layer 32 and the outer layer 36 may be configured by laminating a plurality of resin films of the same type. The resin films may be either stretched or unstretched. The resin films may be a laminate of at least one stretched film and at least one unstretched film. If the intermediate layer 32 and the outer layer 36 has a film that has been arbitrarily stretched in a biaxial direction, the mechanical strength and dimensional stability can be improved.

The thickness of the intermediate layer 32 and the outer layer 36 is not particularly limited, and may be, for example, 3 to 100 mm, or 6 to 50 mm. The resin film may contain at least one type of additive selected from fillers, antistatic agents, plasticizers, lubricants, antioxidants, and the like.

The paper 34 may be, for example, paperboard used for paper containers for liquids. The basis weight of the paper 34 may be, for example, 200 to 500 μm, or 300 to 400 μm. A printed layer may be provided as necessary on the surface of the paper 34 on the outer layer 36 side. The printed layer is a layer configured by an ink containing, for example, a conventionally used binder resin such as a urethane-based, acrylic-based, nitrocellulose-based, or rubber-based binder resin, and additives such as various pigments, plasticizers, desiccants, and stabilizers. The printed layer can be used to display characters, patterns, and the like. As the printing method, for example, known printing methods such as offset printing, gravure printing, flexographic printing, silk screen printing, and inkjet printing can be used.

The laminated body constituting the container for an alcoholic beverage of the present disclosure is not limited to the structure of FIG. 2. For example, arbitrary intermediate layers or adhesive layers may be provided between the constituent layers of the laminated body 50. Examples of adhesive components constituting the adhesive layer include known adhesives such as urethane-based adhesives, polyester-based adhesives, polyamide-based adhesives, epoxy-based adhesives, and isocyanate-based adhesives.

The main body portion 60 of the container for an alcoholic beverage 100 shown in FIG. 1 is configured by bonding parts of a pair of laminated bodies 50 together. The laminated bodies 50 are processed so that the sealing layer 12 of the sealant film 10 is the innermost layer. Therefore, the container for an alcoholic beverage 100 is constructed by bonding together the sealing layers 12 of the pair of sealant films 10, that is, bonding together the other sides 10B so as to face each other at the seal portion 64. Although FIG. 1 only shows the seal portion 64 at the top of the container for an alcoholic beverage 100, seal portions may also be provided at a side portion and a bottom portion of the container for an alcoholic beverage 100. Because the sealing layer 12 has excellent sealing properties, the container for an alcoholic beverage 100 can stably store the alcoholic beverage.

Furthermore, the container for an alcoholic beverage 100 is capable of sufficiently adsorbing the sulfur compounds that cause unpleasant odors generated from the alcoholic beverage as the storage time of the alcoholic beverage elapses, and reduce the unpleasant odors. Alcoholic beverage can sometimes be more likely to generate various sulfur compounds depending on variations in the manufacturing process, storage conditions, and the like. Even in such cases, the container for an alcoholic beverage 100 can sufficiently adsorb the sulfur compounds that cause unpleasant odors, and reduce the unpleasant odors. Therefore, the quality of the alcoholic beverage can be well-preserved over a long period of time.

The alcoholic beverage preferably contains a first component composed of one or more types of substances selected from a group consisting of 3-methyl-1-butanol, phenethyl alcohol, and linalool. The first component is an aroma component that gives rise to the pleasant aroma of Japanese sake, shochu, and the like. The resin layer 11 containing zinc oxide particles suppresses the adsorption of such aroma components. As a result, the flavor of the alcoholic beverage can be even better preserved.

The alcoholic beverages may contain, in addition to hydrogen sulfide, sulfur compounds different from hydrogen sulfide, and sulfur compounds may be generated during storage. The molecular weight of the sulfur compounds other than hydrogen sulfide may be 120 or less. Specific examples include a second component composed of one or more types of substances selected from DMS, methional, methionol, s-methylthioacetate, and DMDS. Such a second component can also be sufficiently adsorbed by the resin layer 11 containing zinc oxide particles. As a result, the unpleasant odors of the alcoholic beverage can be sufficiently reduced.

The resin layer 11 containing zinc oxide particles preferably has a higher total adsorption amount of the second component composed of one or more types of substances selected from a group consisting of DMS, methional, methionol, s-methylthioacetate, and DMDS than the total adsorption amount of the first component composed of one or more types of substances selected from a group consisting of 3-methyl-1-butanol, phenethyl alcohol, and linalool. In this way, by selectively adsorbing the sulfur compounds that cause unpleasant odors over the preferable aroma components, the flavor of alcoholic beverages can be well-preserved.

The procedure by which the laminated body 50 is produced, and the procedure by which the container for an alcoholic beverage 100 and the alcoholic beverage-containing container 120 are produced using the laminated body 50 will be described below. For example, the first surface 10A of the sealant film 10 produced by co-extrusion and the barrier layer 30 are arranged so as to face each other, and then adhered using an adhesive. Then, the intermediate layer 32, the paper 34, and the outer layer 36 are laminated on the barrier layer 30 using an adhesive. The laminated body 50 is obtained in this manner. The laminated body 50 is cut and processed into a predetermined shape. Thereafter, portions of a pair of laminated bodies 50 are overlapped and heat sealed such that the sealing layers 12 face each other. The main body portion 60 of the container for an alcoholic beverage 100 is obtained in this manner. The container for an alcoholic beverage 100 is obtained by attaching the cap 62 to the filling port provided on the upper portion of the main body portion 60.

Then, the cap 62 is removed from the filling port, and the alcoholic beverage is filled from the filling port provided on the upper portion of the main body portion 60. After filling, the alcoholic beverage-containing container 120 is obtained by attaching the cap 62 to seal the filling port.

Although a preferred embodiment of the present disclosure has been described above, the present disclosure is not limited to the above embodiment. For example, the shape of the container for an alcoholic beverage is not limited to having a shape with a triangular roof as shown in FIG. 1, and it may have a box shape or a cylindrical shape. Furthermore, a bag shape (packaging bag) may be used. A bag-shaped container may be a two-sided bag, a three-sided bag, a four-sided bag, a butt-seam bag, or may have a standing pouch shape. The sealant film may be configured by three or more layers. In this case, the resin layer may be configured by two layers, namely a first resin layer and a second resin layer, and the content ratio of zinc oxide particles of one or both of the resin layers may be higher than that of the sealing layer.

### EXAMPLES

The present disclosure will be described in more detail with reference to Examples and Comparative Examples. However, the present disclosure is not limited to the Examples described below.

### Evaluation of H2S Adsorption Properties

### Example 1

### <Production of Resin Composition>

A low-density polyethylene resin (manufactured by Asahi Kasei Corp., product name: Suntec L2170E) and zinc oxide particles that have been subjected to hydrophobic treatment using polysiloxane (manufactured by Sakai Chemical Industry Co., Ltd., product name: FINEX-primary particle size: 35 nm, zinc oxide content: 98% by weight) were blended at a weight ratio of 90:10 to prepare a first resin composition. The first resin composition had an MFR of 4.9 g/10 min and a density of 1.01 g/cm³. A low-density polyethylene resin (manufactured by Asahi Kasei Corp., trade name: Suntec L2170E) was prepared as a second resin composition. The second resin composition had an MFR of 5.3 g/10 min and a density of 0.921 g/cm³. No dispersant was used in either the first resin composition or the second resin composition.

### <Production of Sealant Film>

The first resin composition and the second resin composition were processed into a film using a co-extrusion film forming machine, and a sealant film provided with a two-layer structure having a resin layer (thickness: 45 μm) composed of the first resin composition and a sealing layer (thickness: 15 μm) composed of the second resin composition was produced. A content ratio 1 of zinc oxide particles to the resin layer and a content ratio 2 of zinc oxide particles to the sealant film as a whole were as shown in Table 1. The surface concentration of zinc oxide particles in the resin layer of the sealant film was calculated by the equation below. The results are shown in Table 1.

Surface concentration=density of resin layer x content ratio of zinc oxide particles (% by weight)×thickness of resin layer

The density of the resin layer in the above formula was obtained by dividing the weight of the resin layer by the volume of the resin layer. The weight of the resin layer was obtained by subtracting the weight of the sealing layer obtained from the thickness and the resin density from the weight of the sealant film.

### <Evaluation>

The prepared sealant film was cut into a size of 10 cm×10 cm to obtain a sample. Air containing a predetermined concentration of hydrogen sulfide (H2S) was sealed in a barrier bag containing the sample, and the change in the residual concentration of hydrogen sulfide in the barrier bag over time was measured. A hydrogen sulfide gas generation kit manufactured by Gastech Corp. was used to generate and detect the hydrogen sulfide. The measurement results are shown in Table 3.

### Example 1A

Except for preparing the first resin composition by blending the low-density polyethylene resin and the zinc oxide particles at a weight ratio of 99.2:0.8, and producing the sealant film using this first resin composition, the sealant film was produced in the same manner as in Example 1. The content ratio 1, the content ratio 2, and the surface density were as shown in Table 1. Furthermore, the change in the residual concentration of hydrogen sulfide over time was measured in the same manner as in Example 1. The measurement results are shown in Table 1.

### Example 1B

Except for preparing the first resin composition by blending the low-density polyethylene resin and the zinc oxide particles at a weight ratio of 99:1, and producing the sealant film using this first resin composition, the sealant film was produced in the same manner as in Example 1. The content ratio 1, the content ratio 2, and the surface density were as shown in Table 1. Furthermore, the change in the residual concentration of hydrogen sulfide over time was measured in the same manner as in Example 1. The measurement results are shown in Table 1.

### Example 1C

Except for preparing the first resin composition by blending the low-density polyethylene resin and the zinc oxide particles at a weight ratio of 95:5, and producing the sealant film using this first resin composition, the sealant film was produced in the same manner as in Example 1. The content ratio 1, the content ratio 2, and the surface density were as shown in Table 1. Furthermore, the change in the residual concentration of hydrogen sulfide over time was measured in the same manner as in Example 1. The measurement results are shown in Table 1.

### Example 1D

Except for preparing the first resin composition by blending the low-density polyethylene resin and the zinc oxide particles at a weight ratio of 80:20, and producing the sealant film using this first resin composition, the sealant film was produced in the same manner as in Example 1. The content ratio 1, the content ratio 2, and the surface density were as shown in Table 1. Furthermore, the change in the residual concentration of hydrogen sulfide over time was measured in the same manner as in Example 1. The measurement results are shown in Table 1.

### Example 1E

Except for preparing the first resin composition by blending the low-density polyethylene resin and the zinc oxide particles at a weight ratio of 70:30, and producing the sealant film using this first resin composition, the sealant film was produced in the same manner as in Example 1. The first resin composition had an MFR of 4.6 g/10 min and a density of 1.2 g/cm³. The content ratio 1, the content ratio 2, and the surface density were as shown in Table 1. Furthermore, the change in the residual concentration of hydrogen sulfide over time was measured in the same manner as in Example 1. The measurement results are shown in Table 1.

### Example 2

A low-density polyethylene resin (manufactured by Asahi Kasei Corp., product name: Suntec L2170E) and zinc oxide particles that have been subjected to hydrophobic treatment using polysiloxane (manufactured by Sakai Chemical Industry Co., Ltd., product name: FINEX-50S-LP2, primary particle size: 20 nm, zinc oxide content: 96% by weight) were blended at a weight ratio of 90:10 to prepare a first resin composition. The first resin composition had an MFR of 4.9 g/10 min and a density of 1.00 g/cm³.

Except for using this first resin composition, the sealant film was produced in the same manner as in Example 1. The content ratio 1, the content ratio 2, and the surface density were as shown in Table 1. Furthermore, the change in the residual concentration of hydrogen sulfide over time was measured in the same manner as in Example 1. The measurement results are shown in Table 1.

### Example 3

A low-density polyethylene resin (manufactured by Asahi Kasei Corp., product name: Suntec L2170E) and zinc oxide particles that have not been subjected to surface treatment (manufactured by Sakai Chemical Industry Co., Ltd., product name: 5Z22, primary particle size: 280 nm, zinc oxide content: 100% by weight) were blended at a weight ratio of 90:10 to prepare a first resin composition. The first resin composition had an MFR of 5.0 g/10 min and a density of 1.00 g/cm³.

Except for using this first resin composition, the sealant film was produced in the same manner as in Example 1. The content ratio 1, the content ratio 2, and the surface density were as shown in Table 1. Furthermore, the change in the residual concentration of hydrogen sulfide over time was measured in the same manner as in Example 1. The measurement results are shown in Table 1.

TABLE 1

| | Zinc oxide particles | | | H₂S adsorption evaluation | | | | Change in |
|---|---|---|---|---|---|---|---|---|
| | Content | Content | Surface | (H₂S concentration at each elapsed time) | | | | concentration |
| | ratio 1 | ratio 2 | concentration | Initial | 24 hours | 72 hours | 1 week | after 1 week |
| | [% by weight] | [% by weight] | [g/m²] | [ppm] | [ppm] | [ppm] | [ppm] | [ppm] |
| Example 1 | 10 | 7.5 | 4.52 | 40 | 5 | 0 | 0 | 40 |
| Example 1A | 0.8 | 0.6 | 0.33 | 6.5 | 3 | 1 | 0 | 6.5 |
| Example 1B | 1 | 0.75 | 0.45 | 6 | 2 | 0.8 | 0 | 6 |
| Example 1C | 5 | 3.75 | 2.16 | 6.5 | 1 | 0.3 | 0 | 6.5 |
| Example 1D | 20 | 15 | 9.95 | 35 | 5 | 0 | 0 | 35 |
| Example 1E | 30 | 22.5 | 16.59 | 32 | 3 | 0 | 0 | 32 |
| Example 2 | 10 | 7.5 | 4.52 | 32 | 4 | 0 | 0 | 32 |
| Example 3 | 10 | 7.5 | 4.52 | 29 | 3.5 | 0.5 | 0 | 25 |
| Blank | — | — | — | 36 | 35.5 | 34 | 33 | 3 |

The blank in Table 1 represents the result of measuring the change in the hydrogen sulfide concentration over time when a sealant film was not included in the barrier bag. It was confirmed that the sealant film of each of the Examples are capable of sufficiently adsorbing hydrogen sulfide. From a comparison of Examples 1A, 1B, 1C, 1D, and 1E, it was confirmed that although the sealant films of Examples 1A, 1B, and 1C, which had a low content ratio of zinc oxide particles, had a slow adsorption rate of hydrogen sulfide, the hydrogen sulfide concentration inside the barrier bag could be reduced. From these results, it was confirmed that it is effective for a container of an alcoholic beverage in which hydrogen sulfide is generated to have a resin layer containing zinc oxide particles.

### Evaluation of DMDS Adsorption Properties

### Examples 1, 2, and 3

DMDS was mixed with ethanol to prepare an ethanol solution with a DMDS concentration of 8.79 ppm by weight. The sealant films produced in Examples 1, 2, and 3 were cut into a size of 46 mm×23 mm to obtain samples. The samples were immersed in 10 mL of the above ethanol solution collected in a sample tube, and the change in the adsorption ratio of DMDS over time was measured. A gas chromatograph (detector: SCD) was used to detect DMDS. The heating settings during the measurement were as shown below. The adsorption ratio is the ratio of the DMDS adsorbed by the sample (sealant film) to the total added amount of DMDS, and larger values indicate better adsorption performance. The results are shown in Table 2.

40° C.→heat at 10° C./min→120° C. (2 minute hold)

### Example 2A

Except for preparing the first resin composition by blending the low-density polyethylene resin and the zinc oxide particles at a weight ratio of 95:5, and producing the sealant film using this first resin composition, the sealant film was produced in the same manner as in Example 2. The content ratio 1, the content ratio 2, and the surface concentration were as shown in Table 2. Furthermore, the change in the adsorption ratio of DMDS over time was measured in the same manner as in Example 2. The measurement results are shown in Table 2.

### Example 2B

Except for preparing the first resin composition by blending the low-density polyethylene resin and the zinc oxide particles at a weight ratio of 80:20, and producing the sealant film using this first resin composition, the sealant film was produced in the same manner as in Example 2. The content ratio 1, the content ratio 2, and the surface concentration were as shown in Table 2. Furthermore, the change in the adsorption ratio of DMDS over time was measured in the same manner as in Example 2. The measurement results are shown in Table 2.

TABLE 2

| | Zinc oxide particles | | | DMDS adsorption evaluation (elapsed time) | | | |
|---|---|---|---|---|---|---|---|
| | Content | Content | Surface | 2 hours | 3 hours | 4 hours | 5 hours |
| | ratio 1 | ratio 2 | concentration | Adsorption | Adsorption | Adsorption | Adsorption |
| | [% by weight] | [% by weight] | [g/m²] | ratio [ppm] | ratio [ppm] | ratio [ppm] | ratio [ppm] |
| Example 1 | 10 | 7.5 | 4.52 | 0 | 10 | 33 | 43 |
| Example 2 | 10 | 7.5 | 4.52 | 30 | 29 | 30 | 32 |
| Example 2A | 5 | 3.75 | 2.16 | 0 | 3 | 4 | 16 |
| Example 2B | 20 | 15 | 9.95 | 5 | 9 | 41 | 44 |
| Example 3 | 10 | 7.5 | 4.52 | 23 | 13 | 24 | 25 |

The numerical values for each of the Examples in the “DMDS Adsorption Evaluation” columns in Table 2 indicate the adsorption ratio (% by weight) of DMDS by the sample (sealant film). This adsorption ratio was calculated from the concentration of DMDS remaining in the ethanol solution. Note that, in Example 3, the adsorption ratio after 2 hours was higher than the adsorption ratio after 3 hours, but this is considered to be due to the influence of measurement error. In addition, when the calculated adsorption ratio was a negative value, this was displayed as adsorption rate [%]=0. Such negative values were considered to be due to the influence of measurement error.

The results of Table 1 show that the sealant films of each of Examples 1, 2, 2A, 2B, and 3 were capable of adsorbing DMDS. From a comparison of Examples 2, 2A, and 2B, it was confirmed that as the content of zinc oxide particles was increased, the adsorption ratio of DMDS increased. From these results, it was confirmed that it is effective for a container of an alcoholic beverage in which DMDS is generated to have a resin layer containing zinc oxide particles.

### Evaluation of Adsorption Properties of Sulfur Compounds

### Example 1

The sulfur compounds shown in Table 3 were each mixed with ethanol to prepare five types of ethanol solutions having the initial sulfur compound concentrations shown in Table 3. The sealant film produced in Example 1 was cut into a size of 40 mm×60 mm to obtain a sample. The samples were immersed in 10 mL of each of the ethanol solutions collected in a sample tube, and the change in the adsorption ratio of the sulfur compounds that cause unpleasant odors over time was measured. A gas chromatograph (detector: SCD) was used to detect each of the sulfur compounds. The heating settings during the measurement were as shown below. The measurement results are shown in Table 3.

40° C.→heat at 10° C./min→120° C. (2 minute hold)

TABLE 3

| | Sulfur compounds | | | Elapsed time | |
|---|---|---|---|---|---|
| Measurement | | Molecular | Initial concentration | 6 hours | 24 hours |
| number | Type | weight | [ppm by weight] | Adsorption ratio [%] | Adsorption ratio [%] |
| 1 | DMS | 62.13 | 8.69 | 50 | 63 |
| 2 | Methional | 104.17 | 14.55 | 87 | 90 |
| 3 | Methionol | 106.19 | 14.83 | 89 | 96 |
| 4 | s-Methylthioacetate | 90.14 | 12.59 | 38 | 75 |
| 5 | DMDS | 94.19 | 6.58 | 44 | — |

As shown in Table 3, it was confirmed that the sealant film of Example 1 can sufficiently reduce various sulfur compounds that cause unpleasant odors having a molecular weight of 120 or less. Therefore, when an alcoholic beverage is stored in a container provided with a resin layer containing zinc oxide particles, unpleasant odors can be reduced.

### Evaluation of Adsorption Properties of Aroma Components

### Example 1

The aroma components contained in commercially available shochu products A to F were quantified by gas chromatograph analysis. Among the aroma components, Table 4 shows the quantitative results of 3-methyl-1-butanol and phenethyl alcohol, which are contained in relatively large amounts in shochu and Japanese sake. Table 4 also shows the quantitative results of linalool, whose content ratio is relatively high among terpene alcohols, which are the main aroma component of shochu.

TABLE 4

| | | 3-Methyl-1-butanol | Phenethyl alcohol | Linalool |
|---|---|---|---|---|
| | Type | [ppm by weight] | [ppm by weight] | [ppm by weight] |
| Brand A | Awamori | 874 | 137 | 7.4 |
| Brand B | Rice shochu | 582 | 32 | 1.1 |
| Brand C | Rice shochu | 391 | 15 | 10.4 |
| Brand D | Sweet potato | 454 | 79 | 13 |
| | shochu | | | |
| Brand E | Soba shochu | 558 | 59 | 0.6 |
| Brand F | Barley shochu | 494 | 63 | 7.3 |

Based on the measurement results in Table 4, an ethanol solution for evaluation was prepared by mixing 3-methyl-1-butanol, phenethyl alcohol and linalool with ethanol. The content ratio of 3-methyl-1-butanol in the ethanol solution was 500 ppm by weight, the content ratio of phenethyl alcohol was 50 ppm by weight, and the content ratio of linalool was 5 ppm by weight.

The sealant film produced in Example 1 was cut into a size of 40 mm x 60 mm to obtain a sample. The sample was immersed in 10 mL of the ethanol solution for evaluation collected in a sample tube, and the change in the adsorption ratio of the aroma components over time was measured. A gas chromatograph (detector: FID) was used to detect each of the aroma components. The heating settings during the measurement were as shown below. The measurement results are shown in Table 5. Although some of the calculated adsorption ratios were negative values, this was due to measurement error and it was determined that adsorption ratio [%]=0.

40° C.→heat at 5° C./min→150° C. (3 minute hold)

TABLE 5

| | Adsorption evaluation of aroma components (elapsed time) | | | | |
|---|---|---|---|---|---|
| | Initial | 2 hours | 4 hours | 6 hours | 24 hours |
| | Adsorption | Adsorption | Adsorption | Adsorption | Adsorption |
| | ratio [%] | ratio [%] | ratio [%] | ratio [%] | ratio [%] |
| 3-Methyl-1- | 0 | 0 | 0 | 0 | 0 |
| butanol | | | | | |
| Phenethyl alcohol | 0 | 0 | 0 | 0 | 0 |
| Linalool | 0 | 0 | 0 | 0 | 0 |

As shown in Table 5, it was confirmed that each of the aroma components 3-methyl-1-butanol, phenethyl alcohol and linalool were not adsorbed at all by the resin layer containing zinc oxide particles. As a result, it was confirmed that even when an alcoholic beverage was stored in a container provided with a resin layer containing zinc oxide particles, the flavor of the alcoholic beverage could be well-preserved without a reduction in the aroma components.

### INDUSTRIAL APPLICABILITY

According to the present disclosure, it is possible to provide a container for an alcoholic beverage and an alcoholic beverage-containing container that enable the flavor of an alcoholic beverage to be well-preserved by selectively adsorbing the sulfur compounds that cause unpleasant odors.

### REFERENCE SIGNS LIST

10 . . . Sealant film; 10A . . . First surface; 10B . . . Other side; 11 . . . Resin layer; 12 . . . Sealing layer; 30 . . . Barrier layer; 32 . . . Intermediate layer; 34 . . . Paper; 36 . . . Outer layer; 50 . . . Laminated body; 60 . . . Main body portion; 62 . . . Cap; 64 . . . Seal portion; 100 . . . Container for an alcoholic beverage; 120 . . . Alcoholic beverage-containing container.

What is claimed is:

1. A container for an alcoholic beverage, the container comprising:
a resin layer containing zinc oxide particles.

2. The container for an alcoholic beverage of claim 1, wherein
the zinc oxide particles have a surface that has been subjected to hydrophobic treatment.

3. The container for an alcoholic beverage of claim 1, wherein
a primary particle size of the zinc oxide particles is 20 to 280 nm.

4. The container for an alcoholic beverage of claim 1, wherein
the resin layer contains a polyolefin resin, and
the zinc oxide particles are dispersed in the polyolefin resin.

5. The container for an alcoholic beverage of claim 1, wherein
a content ratio of the zinc oxide particles in the resin layer is 0.2 to 45% by weight.

6. The container for an alcoholic beverage of claim 1, wherein
a surface concentration of the zinc oxide particles in the resin layer is 0.1 g/m² or more.

7. The container for an alcoholic beverage of claim 1, which substantially contains no dispersant.

8. The container for an alcoholic beverage of claim 1, the container being formed of a laminated body provided with a substrate layer containing paper, a barrier layer, and a sealant film in this order from the outside, and having the resin layer provided further to the inside than the barrier layer.

9. The container for an alcoholic beverage of claim 8, wherein
the sealant film contains the resin layer, and a sealing layer further to the inside than the resin layer in which a content ratio of the zinc oxide particles is lower than in the resin layer.

10. The container for an alcoholic beverage of claim 9, wherein
a ratio of a thickness of the resin layer to a thickness of the sealing layer is 1.5 to 5.

11. The container for an alcoholic beverage of claim 8, wherein
a content ratio of the zinc oxide particles in the sealant film as a whole is 0.1 to 25% by weight.

12. The container for an alcoholic beverage of claim 1, the container being for an alcoholic beverage containing at least one selected from a group consisting of Japanese sake and shochu.

13. The container for an alcoholic beverage of claim 1, the container being for a beverage containing a first component composed of one or more types of substances selected from a group consisting of 3-methyl-1-butanol, phenethyl alcohol, and linalool.

14. The container for an alcoholic beverage of claim 1, the container being for a beverage containing a second component composed of one or more types of substances selected from a group consisting of DMS, methional, methionol, s-methylthioacetate, and DMDS.

15. The container for an alcoholic beverage of claim 1, wherein
the resin layer has a higher total adsorption amount of a second component composed of one or more types of substances selected from a group consisting of DMS, methional, methionol, s-methylthioacetate, and DMDS than a total adsorption amount of a first component composed of one or more types of substances selected from a group consisting of 3-methyl-1-butanol, phenethyl alcohol, and linalool.

16. An alcoholic beverage-containing container, comprising:
a container for an alcoholic beverage of claim 1; and
an alcoholic beverage accommodated in the container for an alcoholic beverage.
